(19) United States
(12) Patent Application Publication
(10) Pub. No.: US 2002/0076672 A1
(43) Pub. Date: Jun. 20, 2002

(54) Emergency orthodontics kit of components including a wire cutting and retention tool

(76) Inventors: Harold O. Enoch, Atlanta, GA (US); Charles F. Goetz, Marietta, GA (US)

Correspondence Address: Jason A. Bernstein, BERNSTEIN & ASSOCIATES, P.C., Embassy Row 400, Suite 495, 6600 Peachtree Dunwoody Road, N.E., Atlanta, GA, 30328-1649, US

(21) Appl. No.: 09/955,676

(22) Filed: Sep. 19, 2001

Related U.S. Application Data
(60) Provisional application No. 60/234,260, filed on Sep. 21, 2000.

(51) Int. Cl. A61C 3/02; B65D 83/10

(52) U.S. Cl. 433/145; 206/369

(57) ABSTRACT

An emergency kit of orthodontic tools and components comprising a portable and foldable case which contains a pliers-like wire cutting tool, an elongated plastic rod to effect movement of cut wire ends away from the user's gums, a small container of dental wax, a mouth mirror, and at least one sanitizing wiping cloth. The kit facilitates a user thereof to make minor corrections to braces to relieve discomfort associated with loose or broken wires.

### CROSS REFERENCE TO RELATED APPLICATION

This application claims benefit of co-pending U.S. Provisional Application No. 60/234,260, filed Sep. 21, 2001.

### FIELD OF THE INVENTION

This invention is directed to the field of orthodontics, more particularly to a personal kit of components useful to relieving discomfort caused by broken or loose wires, for example.

### BACKGROUND OF THE INVENTION

The present invention relates to a convenient emergency kit of orthodontic components or tools to assist the user to make temporary repairs to braces without the need for immediate professional assistance.

Braces for one's teeth, as known in the art, may consist of full bands, upper and lower, having bonded brackets to the various teeth, where the various teeth are joined by an archwire, with an elastic band, such as a rubber band, extending between the upper and lower banded brackets. Once the braces are positioned on the patient's teeth, periodic visit are required to the Orthodontist to adjust the teeth as the teeth are pulled together and realigned within one's mouth. Occasionally, the metal wire breaks, leaving an exposed segment of wire with a sharp point which can cut the gum, lip or tongue. Normally, this broken wire must be attended to by the orthodontist using special tools, thus requiring an office visit.

For anyone who has worn braces, or a parent/guardian responsible for overseeing a young one wearing braces, problems with loose or broken wires invariably occur in the evening or on weekends, or at least it seems, when professional help is not immediately available. Heretofore, the best advise to such user or parent/guardian was to place a small piece of dental wax over the cut wire end, or over a loose bracket to stabilize same. However, this was only a make-shift solution until professional help could be arranged. This common problem causes several negative side effects in addition to the discomfort and danger to the patient. Such side effects include the additional time needed for a visit to the orthodontist, and the additional time the orthodontist must be available for evening and weekend call. As many orthodontists charge for their services on a flat fee for the entire orthodonture process (which can extend over months or even years), these wire-mending visits reduce the profitability of the service. Moreover, since these office visits are usually on an emergency or nonroutine (i.e., nonscheduled checkup), the orthodontist's schedule is often upset, or, the patient must suffer through long wait times at the orthodontist's office waiting for an opening in the schedule for what normally is a very short wire mending procedure.

When the broken wire segment is cut the orthodontist must take care that the metal fragment is removed from the patient's mouth so that it is not swallowed or embedded in the skin. With conventional orthodonture wire cutting tools the safe cutting and removal of the wire is achievable by the trained orthodontist or assistant because, in part, they can see better than the patient what they are doing. Conventional wire cutting tools merely cut the wire and the person performing the procedure must be able to see where the wire fragment is going to make sure it does not enter the oral cavity.

It would be desirable to have a tool that would mend the wire breakage and reduce discomfort to the patient that could be performed by the patient anywhere. Such a tool would be able to cut the loose wire while retaining it until removed from the mouth proximity for proper disposal. Such a tool would enable a patient to perform the wire mending procedure without the need for an orthonture trained person being involve.

It would also be desirable to have a convenient patient kit of components or tools to immediately correct these minor problems until professional help can be obtained.

### SUMMARY OF THE INVENTION

The present invention is directed to a kit of orthodontic components or tools conveniently packaged to assist a wearer of braces, or one, such as a parent or guardian, responsible for a youth wearing braces, in correcting minor problems, such as broken wires. The kit comprises a pair of semi-rigid, foldable planar members, joined by a spine, and a snap engaging strap to secure the members in a secure, closed relationship. Within the folded members and mounted to the inner faces of the planar members, such as by elastic bands, are the various tools one might use in correcting a minor orthodontic problem.

Specifically, the tools may include the following:

a. a pliers-like cutting tool to clip broken or loose wires while retaining the broken wire,

b. an elongated plastic rod that can be used to push a wire end away from one's gum, or position wax where needed,

c. dental wax, primarily to cover exposed wire ends, or as a buffer against rough surfaces,

d. mouth mirror, i.e., circular mirror on end of rod, and

e. alcohol wipe to help sanitize the pliers-like cutting tool.

Accordingly, feature of this invention is to provide a convenient, ready-to-use, emergency kit of orthodontic tools or components to be used in attending to minor orthodontic problems.

Another feature of the invention is the provision of a compact kit of orthodontic tools for easy storage in one's home or office, such as a school nurse's office.

These and other features will become apparent to those skilled in the art from a reading of the following description.

### BRIEF DESCRIPTION OF DRAWINGS

The kit of components will now be described with regard to the several Figures, where like reference numerals represent like details or features throughout the several views.

FIG. 1 is a perspective view of the storage folder or case for conveniently storing and displaying the various orthodontic tools or components of this invention.

FIG. 2 is a plan view of the opened storage folder of FIG. 1 showing the displayed orthodontic tools removably secured onto the inner folder faces by plural elastic straps.

FIG. 3 top view of the tool.

FIG. 4 is a rear view of the tool.

FIG. 5 is a top view of the tool.

FIG. 6 is a left side view of the tool.

FIG. 7 is a bottom view of the tool.

FIG. 8 is a front view of the tool.

FIG. 9 is a top plan view of the tool of the present invention in proximity to a row of teeth.

FIG. 10 is a partial right side elevation of the tool shown in proximity to a tooth and brace wire, with the brace wire in the jaw of the tool.

### DETAILED DESCRIPTION OF PREFERRED EMBODIMENT

This invention relates to a kit of orthodontic tools or components, conveniently stored within a foldable case and ready-to-use to correct minor orthodontic problems, such as when professional help is not readily available. The kit of components, including the foldable storage case, will now be described with respect to the accompanying Figures, where like reference numerals represent like features or details throughout the several views.

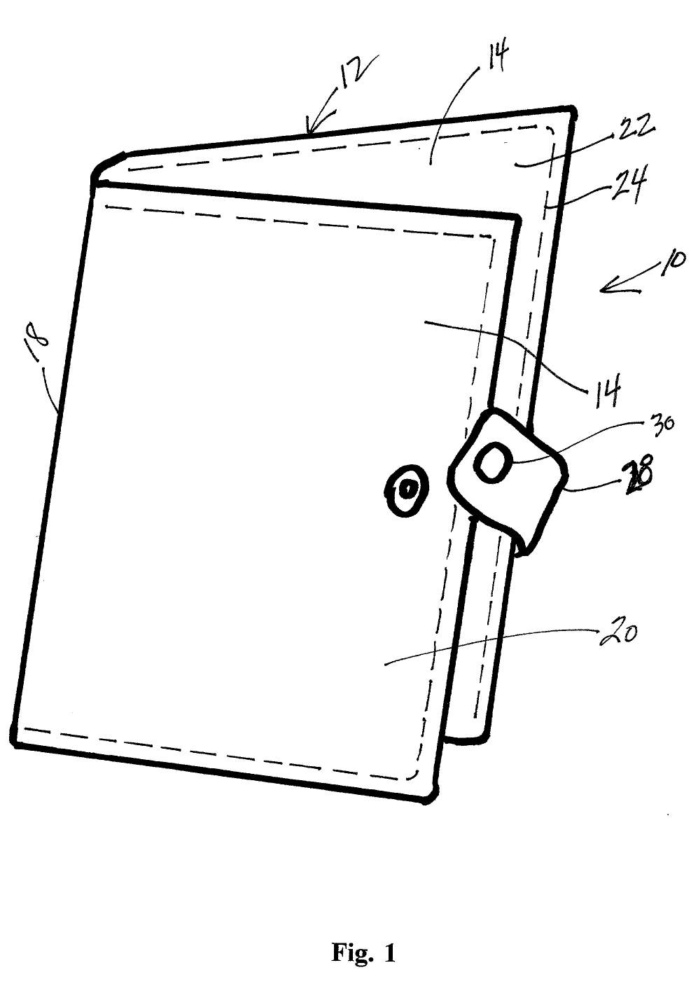

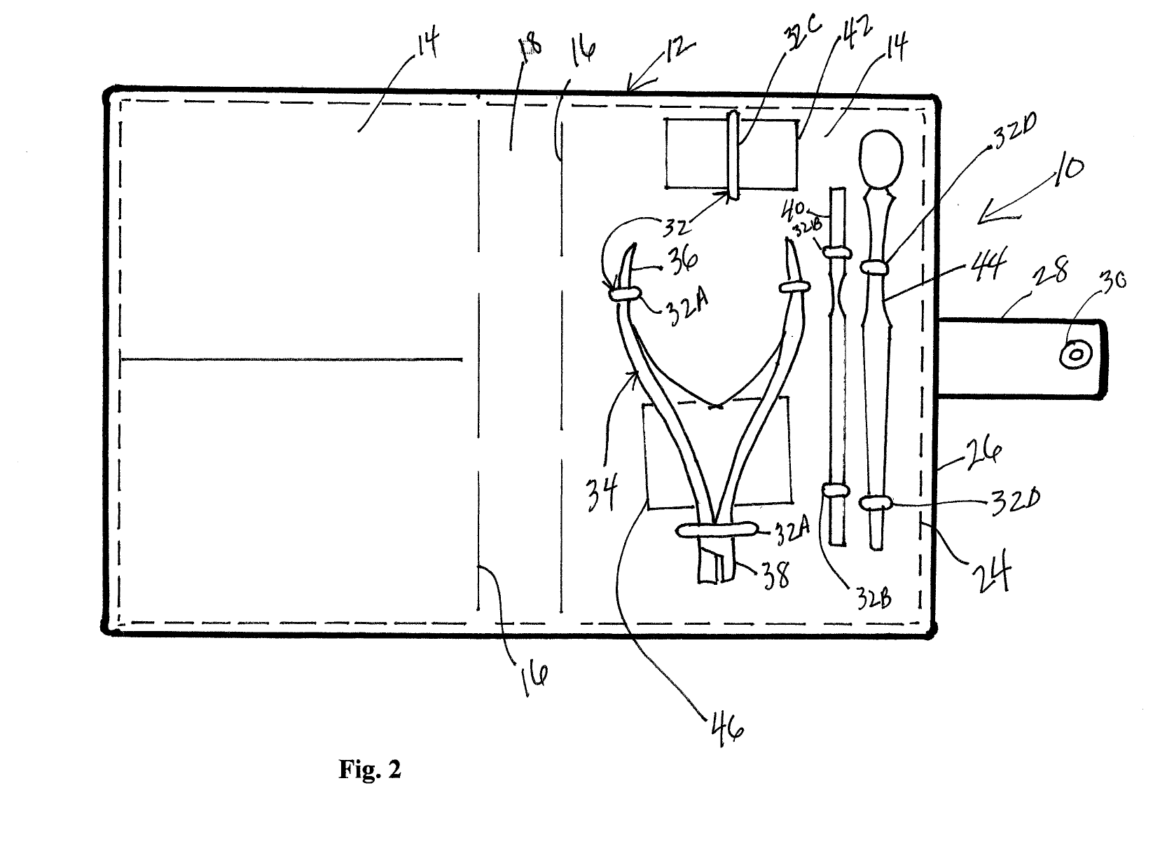

Turning now to FIGS. 1 and 2, the kit 10 of this invention comprises a foldable case 12 consisting of a pair of relatively rigid planar members 14 joined along a pair of member edges 16 by a flexible spine 18. In a preferred embodiment, the case 12 may include a simulated leather, i.e., vinyl, outer face covering 20 wrapped about a pair of spaced apart rigid panel members, not shown, and an inner material face 22, such as a synthetic fabric, all sewn at 24 about the periphery 26 to form an integral unit. Secured to one outer face covering is a laterally extending strap 28 having a snap button recess 30 for engaging a complementary nipple on the opposite outer face covering, as known in the art, to temporarily secure the case 12 in a closed manner. Alternatively, other closure mechanisms known to those skilled in the art can be used, such as zipper, hook and loop, button, adhesive, or the like. Also, the covering can be made of leather, synthetic, plastic or other material.

As best seen in FIG. 2, preferably one inner material face 22 is provided with plural elastic straps 32 strategically positioned to removably receive and snugly secure the various orthodontic tools of this invention. A preferred kit comprises:

a. a pliers-like cutting tool 34 having a pair of hand gripping arms 36 and a uniquely configured head 38 designed to cut broken wires, where the tool 34 is snugly secured by elastic strap 32A;

b. an elongated rod 40, preferably plastic, that may be used to push exposed wire ends away from the user's gums, or to position dental wax where it can be most useful, where the rod 40 is positioned within the aligned elastic straps 32B;

c. dental wax, preferably in a small plastic container 42, to cover exposed wire ends, or as a buffer against rough surfaces, where the container 42 may be secured by elastic strap 32C;

d. mouth mirror 44 featuring a rod mounting a mirror on one end thereof, where the mouth mirror 44 is removably secured to the inner material face by aligned elastic straps 32D; and,

e. an alcohol wipe 46, typically packaged in individual packets, as known in the art, to help sanitize the pliers-like cutting tool 34 after use.

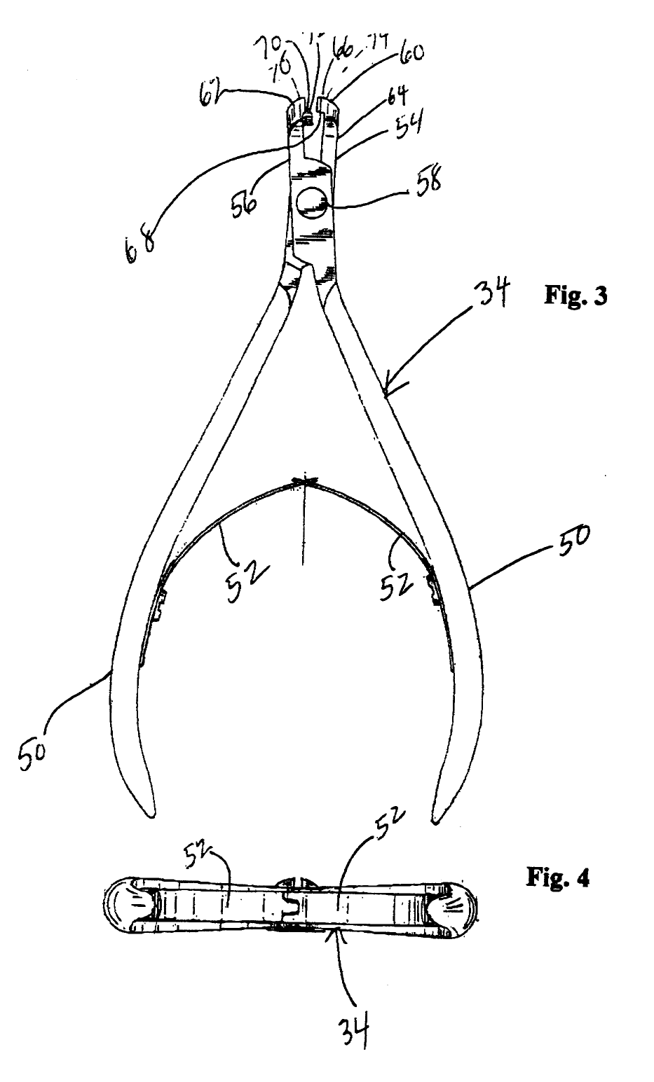

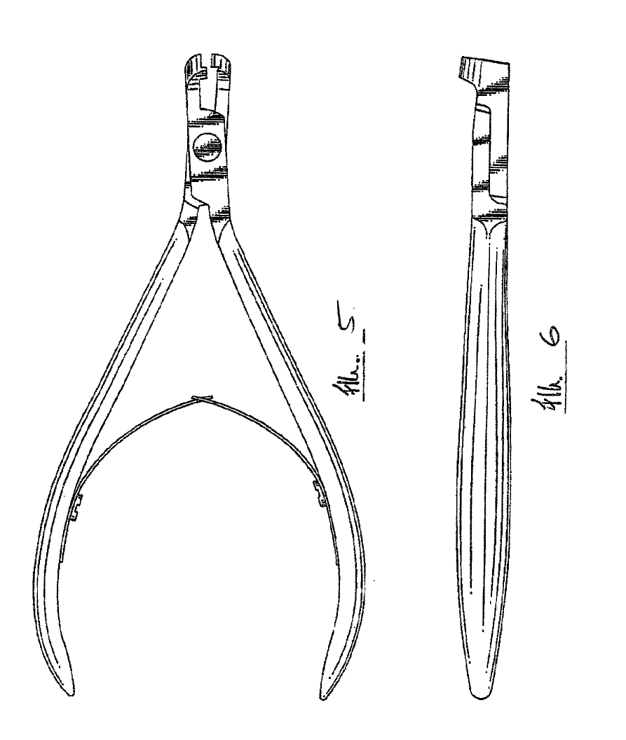

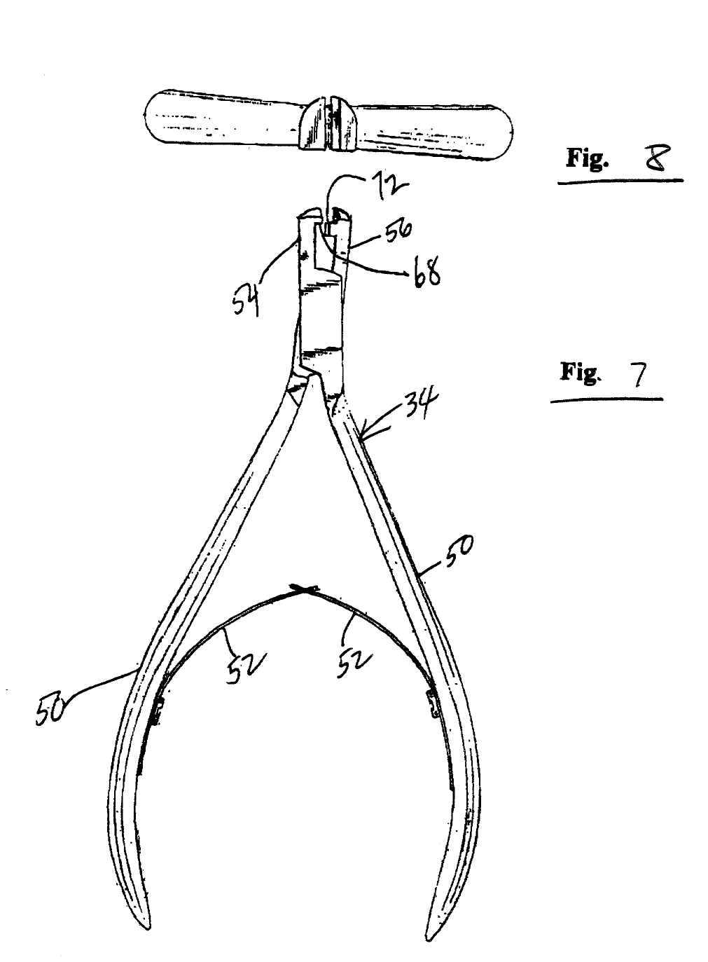

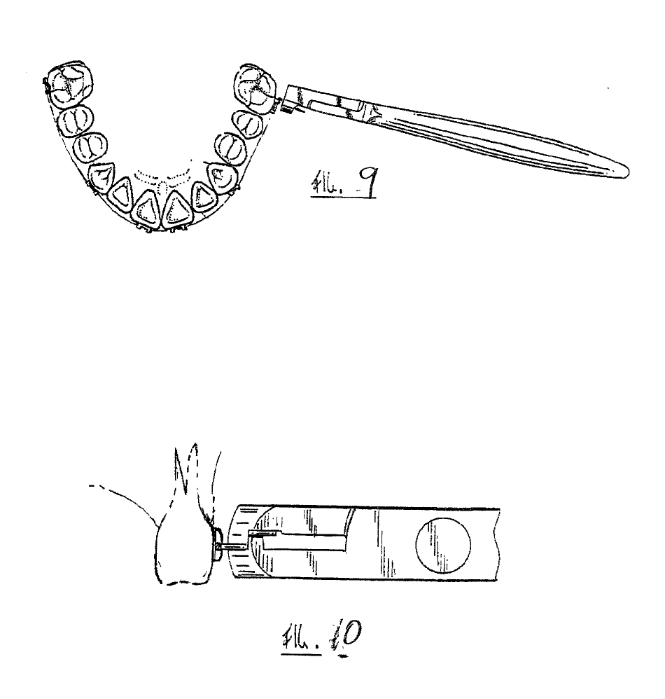

Having just described the components of the kit of the present invention, a preferred wire cutting tool 34 hereof is illustrated in FIGS. 3-8. The preferred tool 34 comprises a pair of cooperating hand-gripping arms 50, biased away from one another by a pair of interlocking arcuate spring members 52, such that after cutting a wire, as later described, the interlocking spring members will open the tool. In any case, the respective hand-gripping arms 50 terminate in pivotal head elements 54, 56 about a pivot pin 58 spaced from free ends 60, 62.

The respective free ends are uniquely designed to cooperate with one another to clearly cut, or sever a broken wire that may be causing discomfort to the wearer of braces. A first free end 60 is L-shaped having a base leg 64, and a later al, inwardly directed leg 66 featuring a wire shearing face 68. The second free end 62 is essentially T-configured and includes an inwardly directed leg 7- having a cooperative shearing face 72, where the leg 70 is positioned to cooperate with the second leg 66, whereby the opposing shearing faces 68 and 72 interact to cut or sever a selected broken wire adjacent or in close proximity to the brace. Since comfort is a prerequisite to using the tool, the tips 74, 76, respectively of free ends 60, 62, may be rounded to avoid sharply impacting the gums of the wearer of the braces.

To use the tool 34, as the tool is extracted from the kit 10, the spring members 52 are in the resoled condition and the tool is ready for use. The tool, as opened, is placed over the broken wire and the pair of arms 50 are squeezed toward one another. This closes the mating free ends 60, 62, thus exerting a shearing force and cutting the broken wire. When the grip on the arms 50 is released, the spring members take over to open the tool for a second broken wire, if necessary, or to return the tool to its nesting position within the kit 10.

It is recognized that variations, changes or modifications may be made to the kit of orthodontic components of this invention, particularly by those skilled in the art, without departing from the spirit and scope of the invention. All patents, applications and documents referred to herein are incorporated by reference in their entirety.

Claimed is:

1. A portable kit of orthodontic components and tools to effect relief of the discomfort of wires on braces worn by a user of said kit, said kit comprising:
a. a portable case for removably receiving and storing said components and tools;
b. a wire cutting tool;
c. an elongated rod for effecting movement of said wires;
d. quantity of dental wax;
e. a mouth mirror, and,
f. at least one sanitizing wiping cloth.

2. The portable orthodontic emergency kit of claim 1, wherein said portable case comprises a pair of spaced apart, relatively rigid planar members joined by an outer wrap covering and an inner fabric liner, where said outer wrap covering and inner fabric liner between the said planar members define a flexible spine to allow folding of one said planar member onto said second planar member.

3. The portable orthodontic emergency kit of claim 2, wherein means are provided to temporarily secure said planar members in a closed and folded position.

4. The portable orthodontic emergency kit of claim 3, wherein said means comprises a flexible strap secured to the outer face of a first said planar member, where a free end of said strap mounts a snap fastener for engaging a complementary fastening member mounted on the opposite said planar member.

5. The portable orthodontic emergency kit of claim 2, wherein at least one said inner fabric liner includes a plurality of looped elastic members for removably securing tools and components within said case in the closed and folded position.

6. The portable orthodontic emergency kit of claim 1, wherein said wire cutting tool includes a pair of squeezable arms operate to open and close a head member where said head member is operable to effect cutting of said brace wire.

7. The portable orthodontic emergency kit of claim 6, wherein said head member includes a pair of cooperating end portions to effect a shearing cut of said brace wire.

8. The portable orthodontic emergency kit of claim 7, wherein said squeezable arms are separated by at least one arcuate spring member operable to move said arms from a closed position to an open position.

9. The portable orthodontic emergency kit of claim 8, wherein there are a pair of interlocking arcuate spring members.

10. An orthodontic wire cutting tool to effect relief of the discomfort of wire on braces, said tool comprising:
a. a pair of squeezable arms pivotally mounted to one another and operable from an open position to a closed position to effect a cutting of said wire, where each said arm is characterized by a hand gripping portion and a head portion;
b. at least one arcuate spring member extending between said hand gripping portions to facilitate moving said tool between said open position to said closed position;
c. the first said head portion including a first inwardly directed projection, where said first projection cooperates with said second head portion to hold said wire in said closed position, said first head portion further including a first wire shearing face; and,
d. the second said head portion having a second inwardly directed projection operable to override said first inwardly directed projection, where said second projection includes a second wire shearing face for cooperation with said first projection to effect a cutting of said wire.

11. A portable kit of orthodontic components and tools to effect relief of the discomfort of wires on braces worn by a user of said kit, said kit comprising a portable case for removably receiving and storing said components and tools, where said case includes,
a. a pliers-like wire cutting tool;
b. a first elongated plastic rod for effecting movement of said wires;
c. a container containing a quantity of dental wax;
d. a second elongated mounting a mouth mirror; and,
e. at least one sanitizing wiping cloth underlying said pliers-like cutting tool.

12. The portable orthodontic emergency kit of claim 11, wherein said portable case comprises a pair of spaced apart, relatively rigid planar members joined by an outer wrap covering and an inner fabric liner, where said outer wrap covering and inner fabric liner between the said planar members define a flexible spine to allow folding of one said planar member onto said second planar member.

13. The portable orthodontic emergency kit of claim 12, wherein means are provided to temporarily secure said planar members in a closed and folded position.

14. The portable orthodontic emergency kit of claim 13, wherein said means comprises a flexible strap secured to the outer face of a first said planar member, where a free end of said strap mounts a snap fastener for engaging a complementary fastening member mounted on the opposite said planar member.

15. The portable orthodontic emergency kit of claim 12, wherein at least one said inner fabric liner includes a plurality of looped elastic members for removably securing said tools and components within said case in the closed and folded position.

16. The portable orthodontic emergency kit of claim 11, wherein said pliers-like wire cutting tool includes a pair of squeezable arms operable to open and close a head member where said head member is operable to effect cutting of said brace wire.

17. The portable orthodontic emergency kit of claim 16, wherein said head member includes a pair of cooperating end portions to effect a shearing cut of said brace wire.

18. The portable orthodontic emergency kit of claim 17, wherein said squeezable arms are separated by at least one arcuate spring member operable to move said arms from a closed position to an open position.

19. The portable orthodontic emergency kit of claim 18, wherein there are a pair of interlocking arcuate spring members.
